(19) United States
(12) Patent Application Publication
(10) Pub. No.: US 2022/0389589 A1
(43) Pub. Date: Dec. 8, 2022

(54) MULTIPLE NOZZLE DESIGN IN A COLD SPRAY SYSTEM AND ASSOCIATED METHOD

(71) Applicant: Westinghouse Electric Company LLC, Cranberry Township, PA (US)

(72) Inventors: Guoqiang WANG, Murrysville, PA (US); Benjamin MAIER, Pittsburgh, PA (US); Arash PARSI, Sarver, PA (US)

(73) Assignee: Westinghouse Electric Company LLC, Cranberry Township, PA (US)

(21) Appl. No.: 17/755,030

(22) PCT Filed: Oct. 20, 2020
(86) PCT No.: PCT/US2020/056420

§ 371 Date: Apr. 19, 2022

Related U.S. Application Data
(60) Provisional application No. 62/923,878, filed on Oct. 21, 2019.

(51) Int. Cl. C23C 24/04; B05B 13/04

(52) U.S. Cl. CPC C23C 24/04; B05B 13/0431; B05B 13/0436

(57) ABSTRACT

Disclosed herein is a cold spray system. The cold spray system comprises a nozzle unit comprising a coating nozzle member, configured to apply at least a portion of a metallic coating to a substrate. The cold spray system is configured to pre-heat the substrate before application of the at least a portion of the metallic coating to the substrate. Also disclosed herein is a method for applying a coating via a cold spray technique.

### CROSS-REFERENCE TO RELATED APPLICATIONS

This application claims the benefit of U.S. provisional Application No. 62/923,878, filed Oct. 21, 2019 entitled “MULTIPLE NOZZLE DESIGN IN A COLD SPRAY SYSTEM FOR ACCIDENT TOLERANT FUEL PRODUCTION.” The contents of which are incorporated by reference herein.

### BACKGROUND

### 1. Field

The present disclosure relates to an apparatus and method for applying a cold spray coating.

### 2. Related Art

Accident-tolerant fuel (ATF) is a term used to describe new technologies that enhance the safety and performance of nuclear fuel. Such fuels may incorporate the use of new materials and designs for cladding and fuel pellets. An objective of such fuels is to better tolerate the loss of active cooling in the reactor core, while maintaining or improving fuel performance and economics during normal operations.

Cold Spray deposition is an excellent method for coating a chromium (Cr) layer on a base Zr-alloy fuel cladding such as ZIRLO® or Optimized ZIRLO™ cladding, which will be a product related to Westinghouse EnCore® Accident Tolerant Fuel. However, there is limited availability of helium for use as the carrier gas for cold spray. Also, helium is very expensive to consume during cold spray, and no entirely satisfactory solution has been found. Nitrogen is an alternative gas that can be used to replace helium in cold spray. However, with the current system design, the cold spray nozzle traverse velocity with nitrogen is limited in order to maintain a satisfactory coating thickness. Accordingly, the overall cost for making Cr-coated cladding is still relatively high.

### SUMMARY

The present disclosure provides a new multiple nozzle design in a cold spray system that may be employed for ATF production. The arrangement uses several nozzles to achieve an optionally hermetic metallic coated layer on a cladding that can function at real operating conditions in a PWR or BWR, even in accident situations. The multiple nozzles are laid out in three (3) dimensions, e.g., not necessary in the same plane. The design is capable of coating a high quality chromium layer with nitrogen while increasing the nozzle traverse velocity.

Disclosed herein is a cold spray system. The cold spray system comprises a nozzle unit comprising a coating nozzle member, configured to apply at least a portion of a metallic coating to a substrate. The cold spray system is configured to pre-heat the substrate before application of the at least a portion of the metallic coating to the substrate.

Also disclosed herein is a method for applying a coating via a cold spray technique. The method comprises pre-heating a substrate and applying at least a portion of a metallic coating to the pre-heated substrate.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

A further understanding of the disclosure can be gained from the following description of the preferred embodiments when read in conjunction with the accompanying drawings in which:

FIG. 1 is a partially schematic perspective view of a dual nozzle arrangement in accordance with one example of the present disclosure for applying a coating on a fuel rod cladding; and

FIG. 2 is a partially schematic perspective view of another arrangement in accordance with one example of the present disclosure that utilizes three of the dual nozzle arrangements for applying coatings to three rods concurrently.

### DETAILED DESCRIPTION

In the following description, like reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms. As used herein, the term “number” shall be used to refer to any non-zero integer quantity, i.e., one or any integer greater than one (e.g., 1, 2, 3, . . . ).

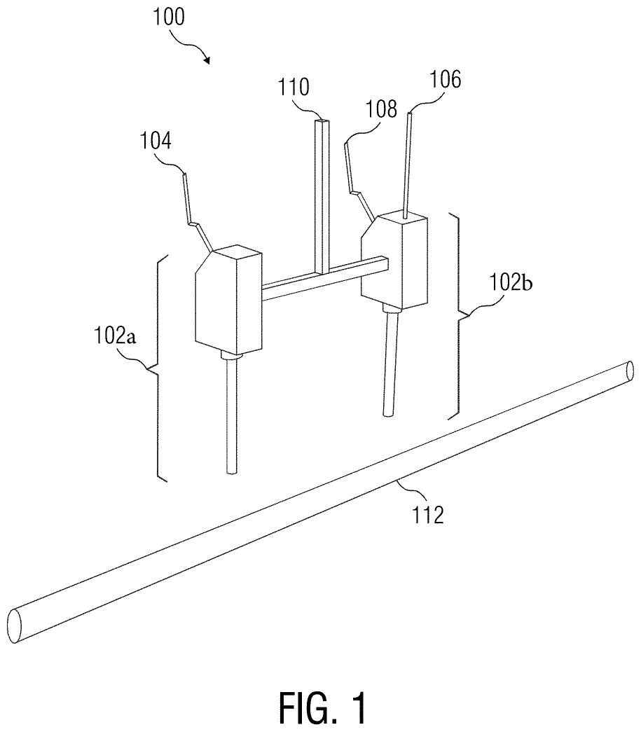

The present disclosure includes a cold spray system comprising one or more nozzle members for applying a cold spray coating. The nozzle members can be arranged in pairs to form dual nozzle units. As used herein, “dual” implies a pair of nozzle members. However, unless otherwise stated, examples comprising more than two nozzle members per unit are also contemplated when “dual” is used. A partially schematic view of a dual nozzle unit 100 in accordance with the present disclosure is shown in FIG. 1. The exemplary dual nozzle unit 100 shown in FIG. 1 can comprise various components (e.g., 102-110). A pre-heating nozzle member 102a can function as a pre-heater to heat a substrate 112 (e.g., a cladding tube). Alternatively or additionally, the substrate 112 may also be pre-cleaned by the pre-heating nozzle member 102a (e.g., by the pre-heating nozzle member 102a blowing hot gas over the substrate 112). The cold spray system can further comprise a coating nozzle member 102b. The coating nozzle member 102b can be configured to apply at least a portion of a metallic coating to the pre-heated substrate 112 via a cold spray process. As used herein, “pre-heating” means increasing the temperature of the substrate above an ambient temperature before at least a portion of the metallic coating is applied to the substrate 112 via a cold spray process.

Alternatively or in addition to the pre-heating nozzle member 102a, other heat sources may be included. The cold spray system can thus can comprise a heat gun, a pre-heating chamber, an induction heating element, an electrical local heating device, or a combination thereof to pre-heat and/or pre-clean the substrate 112.

The substrate 112 can comprise, for example, a zirconium or zirconium alloy tube (e.g., a nuclear fuel rod cladding, a control rod cladding). The zirconium alloy can comprise, for example, an alloy comprising zirconium and tin and/or niobium (e.g., ZIRLO® and Optimized ZIRLO™ alloys available from Westinghouse Electric Company of Cranberry Twp, Pennsylvania, United States).

The metallic coating can be applied to the substrate 112 via a cold spray process executed by a cold spray system of the present disclosure. The metallic coating can comprise a single metallic material or alloy, or the metallic coating can comprise multiple layers or regions, with the respective layers or regions comprising different metallic materials or alloys. Without limitation, the metallic coating can be applied using metallic materials (e.g., powders) comprising one or more of chromium, niobium, copper, nickel, and aluminum. Although described herein for use in applying coatings for ATF production, it is to be appreciated that the systems and components described herein may be used for other cold spray applications, e.g., crack repairs, pipe coatings, or other coatings, etc., without departing from the scope of the present disclosure.

When employed, the pre-heating nozzle member 102a can optionally deposit a first layer of the metallic coating onto the substrate 112, in addition to pre-heating and/or pre-cleaning the substrate 112. The application of the first layer of the metallic coating can also accomplish pre-heating/pre-cleaning of the substrate 112. The coating nozzle member 102b may then apply a second coating layer to the same area of the substrate 112 that was first coated and pre-heated by the pre-heating nozzle member 102a. The substrate 112 may move relative to the dual nozzle unit 100, and/or the unit 100 may move relative to the substrate 112. In this manner, a multilayer coating can be formed. The multilayer coating can comprise, for example, niobium disposed on the substrate 112 by the pre-heating nozzle member 102a and chromium disposed on the niobium by the coating nozzle 102b.

When the pre-heating nozzle member 102a is not used to deposit a coating (but is still used to pre-heat/pre-clean the substrate), the pre-heating nozzle member 102a can be supplied with a heated and/or pressurized gas. The gas can be heated such that the substrate 112 is not heated above its oxidation acceleration threshold (e.g., not above 500° C. not above 400° C., not above 300° C.). In this case, the heated gas can comprise a carrier gas as described below and/or another gas such as air. In this case, the coating nozzle member 102b can apply a single layer coating, e.g., a coating comprising chromium.

When the pre-heating nozzle member 102a is used to deposit a coating and is used to pre-heat/pre-clean the substrate, the pre-heating nozzle member can be supplied with a heated carrier gas and metallic coating material (e.g., a powder).

A gas line 104 can be connected to the pre-heating nozzle member 102a, and heated and/or pressurized gas can be delivered to the pre-heating nozzle member 102a from the gas line 104. The heated gas can act as the medium carrying heat to the substrate 112 in order to accomplish pre-heating/pre-cleaning of the substrate 112. The dual nozzle unit 100 can optionally comprise a second line (not shown) in communication with the pre-heating nozzle member 102a. When a second line is present, the gas line 104 can deliver a heated carrier gas, and the second line can deliver a metallic coating material (e.g., a metal powder, as described above). When both lines are present, the pre-heating nozzle member 102a can also mix the gas and powder and/or allow for the gas to heat the powder before application.

Two lines 106, 108 can be in communication with the coating nozzle member 102b. Line 106 can carry the heated and/or pressurized carrier gas and can deliver the gas to the coating nozzle member 102b. Line 108 can carry the metallic coating material. The coating nozzle member 102b can also mix the gas and powder and allow for the gas to heat the powder before application.

Gas and/or powder delivery lines 104, 106, 108 can comprise flexible lines.

The nozzle connector 110 allows the two nozzles 102a, 102b to be tightened and aligned with the substrate 112 together. The other end of the nozzle connector 110 may be connected to a robotic arm (not shown) for manipulating the unit about the substrate 112 or may be fixed in place and the substrate 112 moved with respect to the static unit 100.

Regarding the cold spray process, the method may proceed by delivering a carrier gas to a heater where the carrier gas is heated to a temperature sufficient to maintain the gas at a desired temperature. The desired temperature (after expansion of the gas as it passes through the nozzle member 102a, 102b) may be less than one half the melting temperature of the metallic coating material (e.g., from 100° C. to 750° C.). The desired temperature can also be below the oxidation acceleration temperature (e.g., 400° C. to 500° C.) for the substrate 112. The carrier gas may be initially pressurized with a pressure, for example, of 5.0 MPa.

The carrier gas may optionally be pre-heated to a temperature between 200° C. and 1000° C., between 300° C. and 900° C., or between 500° C. and 800° C. The optional pre-heating temperature will depend on the Joule-Thomson cooling coefficient of the particular gas used as the carrier. Whether or not a gas cools upon expansion or compression when subjected to pressure changes depends on the value of its Joule-Thomson coefficient. For positive Joule-Thomson coefficients, the carrier gas cools and must be preheated to prevent excessive cooling which can affect the performance of the cold spray process. Those skilled in the art can determine the degree of heating using calculations to prevent excessive cooling. See, for example, for N₂ as a carrier gas, if the inlet temperature is 130° C., the Joule-Thomson coefficient is 0.1° C./bar. For the gas to impact the tube at 130° C. if its initial pressure is 10 bar (˜146.9 psig) and the final pressure is 1 bar (˜14.69 psig), then the gas needs to be preheated to about 9 bar*0.1° C./bar or about 0.9° C. to about 130.9° C. As another example, the temperature for helium gas as the carrier can be 450° C. at a pressure of 3.0 to 4.0 MPa, and the temperature for nitrogen as the carrier can be 1100° C. at a pressure of 5.0 MPa, but may also be 600° C.-800° C. at a pressure of 3.0 to 4.0 MPa. Those skilled in the art will recognize that the temperature and pressure variables may change depending on the type of the equipment used and that equipment can be modified to adjust the temperature, pressure and volume parameters.

The cold spray process relies on the controlled expansion of the heated carrier gas to propel the particles onto the substrate 112. The particles impact the substrate 112 or a previously deposited layer and undergo plastic deformation through adiabatic shear. Subsequent particle impacts build up to form the coating. The particles may also be warmed to temperatures one-third to one-half the melting point of the powder before entering the flowing carrier gas in order to promote deformation. The nozzles 102a, 102b can be rastered (e.g., sprayed in a pattern in which an area is sprayed from side to side in lines from top to bottom) across the area to be coated or where material buildup is needed.

Suitable carrier gases are those that are inert (e.g., not reactive), and those that particularly will not react with the particles or the substrate 112. Exemplary carrier gases include nitrogen (N₂), argon (Ar), carbon dioxide (CO₂), and helium (He).

There is considerable flexibility in regard to the selected carrier gases. Mixtures of gases may be used. Selection is driven by both physics and economics. For example, lower molecular weight gases provide higher velocities, but the highest velocities should be avoided as they could lead to a rebound of particles and therefore diminish the number of deposited particles. The present disclosure allows for increased flexibility in the choice of carrier gas and can allow for increased use of nitrogen, rather helium, while maintaining or improving coating quality and deposition speed.

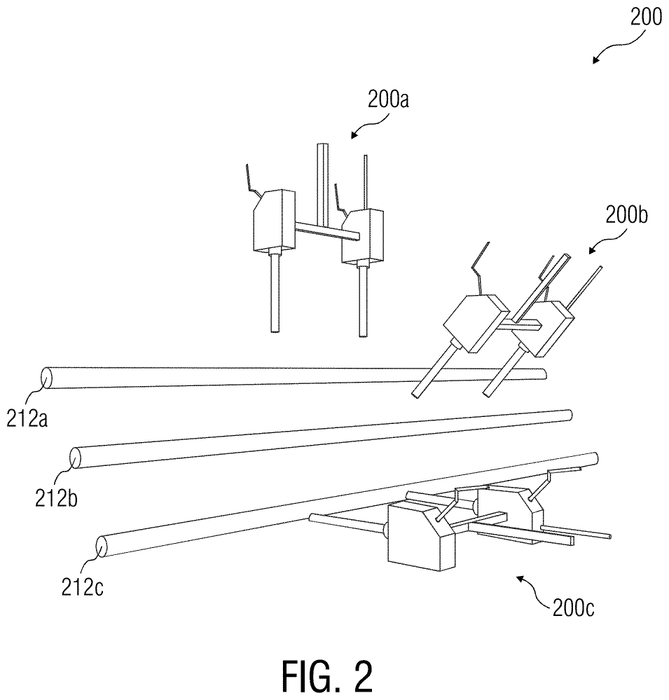

A partially schematic view of a multiple nozzle design 200 in a cold spray system is shown in FIG. 2. Typically, a multiple nozzle system 200 can comprise two or more dual nozzle unit(s) 100, such as the dual nozzle unit previously discussed in regard to FIG. 1. For example. FIG. 2 shows three dual nozzle unit(s) 200a, 200b, and 200c controlled together by one cold spray system. Dual nozzle units 200a, 200b, 200c can be aligned with substrates 212a, 212b, and 212c, respectively. The three dual nozzle units 200a, 200b, 200c are controlled by one cold spray system, which can be integrated with robotic arms or fixed in place as the substrate moves relative to the static nozzles. The three Zr-alloy cladding tubes (for example) can be coated simultaneously. With such multiple nozzle design 200 the production rate of coated substrate 212a-c can be further increased. For example the design shown in FIG. 2 would increase the production rate by three times (as compared to one dual nozzle unit 100). In summary, with N dual nozzle units, the production rate can be increased N times (as compared to one dual nozzle unit). Note that the dual nozzle units, the powder feeders, the robotic controls, and the cold spray main unit can all optionally be integrated together for an optimized operation.

A cold spray system of the present disclosure can further comprise additional components. For example, the cold spray system can comprising one or more of a plurality of the nozzle units 200a-c, a plurality of powder feeders (and feed lines 108) to supply powder to the nozzle units 200a-c, robotic controls to provide an operator means to control the system, and a cold spray main unit that are integrated together for operation.

In summary, multiple nozzles are key new devices in a cold spray system that is utilized for coating substrates such as fuel rod claddings. Such devices are very practical to install and can be constructed for producing coated claddings more efficiently by increasing the amount of deposited powder (by pre-heating/pre-cleaning the substrate) and with higher coating quality.

Also disclosed herein is a method for applying a coating via a cold spray technique. The method can be carried out by a cold spray system as disclosed herein. The method can comprise pre-heating a substrate 112, 212a-c that is to be coated and applying at least a portion of a metallic coating to the pre-heated substrate. The pre-heating can be accomplished by any heat source as described herein and can serve to increase the bonding between the substrate 112, 212a-c and the coating.

Pre-heating the substrate 112, 212a-c can be accomplished via a nozzle member or a heat gun, which can blow hot gas onto the substrate 112, 212a-c; a pre-heating chamber, in which the substrate 112, 212a-c can be located for a time before at least a portion of the coating is applied; an induction heating element, which can induce an electrical current in the substrate 112, 212a-c to heat the substrate 112, 212a-c; an electrical local heating device; or a combination thereof.

Pre-heating the substrate 112, 212a-c can be accomplished via a pre-heating nozzle member 102a, and at least a portion of the metallic coating can be applied via a coating nozzle member 102b.

The pre-heating nozzle member 102a can optionally also apply a first portion of the metallic coating, thereby pre-heating and coating the substrate 112, 212a-c, and the coating nozzle member 102b can apply a second portion of the metallic coating.

The method can further comprise pre-cleaning the substrate 112, 212a-c using the first nozzle member 102a.

A benefit of the cold spray system and methods as described herein is that after pre-heating the substrate 112, 212a-c, a metallic coating layer with improved bonding strength and hermeticity can be accomplished. The pre-heating can improve the bond formation between the substrate 112, 212a-c and the coating or between two coatings. Additionally, the pre-heating can increase the possible deposition and/or traversal speeds (due to, for example, the improved bonding to the substrate). Pre-cleaning can also remove contaminants that would interfere with the coating process such as residues, chemical impurities, and/or particulate debris. This approach not only extensively improves the quality of the coating layer but also successfully increases the production rate.

Additionally, the cold spray system as described herein can allow for time and cost savings during coating of substrates by using less expensive nitrogen gas that at least partially replaces helium, which is more expensive and difficult to obtain.

Various aspects of the subject matter described herein are set out in the following examples.

Example 1—A cold spray system comprising a nozzle unit. The nozzle unit comprises a coating nozzle member, configured to apply at least a portion of a metallic coating to a substrate. The cold spray system is configured to pre-heat the substrate before application of the at least a portion of the metallic coating to the substrate.

Example 2—The cold spray system of Example 1, wherein the nozzle unit further comprises a pre-heating nozzle member, a heat gun, a pre-heating chamber, an induction heating element, an electrical local heating device, or a combination thereof that is configured to pre-heat the substrate before application of the at least a portion of the metallic coating to the substrate.

Example 3—The cold spray system of Example 1 or 2, further comprising a pre-heating nozzle member configured to pre-heat the substrate before application of the at least a portion of the metallic coating to the substrate.

Example 4—The cold spray system of Example 3, wherein the pre-heating nozzle is configured to both pre-heat the substrate before application of the at least a portion of the metallic coating to the substrate and to apply a portion of the metallic coating to the substrate.

Example 5—The cold spray system of Example 3 or 4, wherein the pre-heating nozzle and the coating nozzle are configured to apply two different metallic coating components, respectively.

Example 6—The cold spray system of any of Examples 1-5, comprising one or more of a plurality of the nozzle units, a plurality of powder feeders, robotic controls, and a cold spray main unit that are integrated together for operation.

Example 7—A method for applying a coating via a cold spray technique comprising pre-heating a substrate and applying at least a portion of a metallic coating to the pre-heated substrate.

Example 8—The method of Example 7, wherein the pre-heating is accomplished via a pre-heating nozzle member, a heat gun, a pre-heating chamber, an induction heating element, an electrical local heating device, or a combination thereof that is configured to pre-heat the substrate.

Example 9—The method of Example 7 or 8, wherein the pre-heating is accomplished via a pre-heating nozzle member, and the at least a portion of the metallic coating is applied via a coating nozzle member.

Example 10—The method of Example 9, wherein the pre-heating nozzle member applies a first portion of the metallic coating, thereby coating and pre-heating the substrate, and the second nozzle member applies a second portion of the metallic coating.

Example 11—The method of Example 9 or 10, further comprising pre-cleaning the substrate using the pre-heating nozzle member.

Example 12—The method of Example 9, wherein the metallic coating comprises chromium.

Example 13—The method of Example 10, wherein the first portion of the metallic coating comprises niobium and the second portion of the metallic coating comprises chromium.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A cold spray system comprising:
a nozzle unit comprising:
a coating nozzle member, configured to apply at least a portion of a metallic coating to a substrate,
wherein the cold spray system is configured to pre-heat the substrate before application of the at least a portion of the metallic coating to the substrate.

2. The cold spray system of claim 1, wherein the nozzle unit further comprises a pre-heating nozzle member, a heat gun, a pre-heating chamber, an induction heating element, an electrical local heating device, or a combination thereof that is configured to pre-heat the substrate before application of the at least a portion of the metallic coating to the substrate.

3. The cold spray system of claim 1, further comprising:
a pre-heating nozzle member configured to pre-heat the substrate before application of the at least a portion of the metallic coating to the substrate.

4. The cold spray system of claim 3, wherein the pre-heating nozzle is configured to both pre-heat the substrate before application of the at least a portion of the metallic coating to the substrate and to apply a portion of the metallic coating to the substrate.

5. The cold spray system of claim 3, wherein the pre-heating nozzle and the coating nozzle are configured to apply two different metallic coating components, respectively.

6. The cold spray system of claim 1, comprising one or more of a plurality of the nozzle units, a plurality of powder feeders, robotic controls, and a cold spray main unit that are integrated together for operation.

7. A method for applying a coating via a cold spray technique comprising:
pre-heating a substrate and
applying at least a portion of a metallic coating to the pre-heated substrate.

8. The method of claim 7, wherein the pre-heating is accomplished via a pre-heating nozzle member, a heat gun, a pre-heating chamber, an induction heating element, an electrical local heating device, or a combination thereof that is configured to pre-heat the substrate.

9. The method of claim 7, wherein the pre-heating is accomplished via a pre-heating nozzle member, and the at least a portion of the metallic coating is applied via a coating nozzle member.

10. The method of claim 9, wherein the pre-heating nozzle member applies a first portion of the metallic coating, thereby coating and pre-heating the substrate, and the second nozzle member applies a second portion of the metallic coating.

11. The method of claim 9, further comprising pre-cleaning the substrate using the pre-heating nozzle member.

12. The method of claim 9, wherein the metallic coating comprises chromium.

13. The method of claim 10, wherein the first portion of the metallic coating comprises niobium and the second portion of the metallic coating comprises chromium.
